(19) United States
(12) Patent Application Publication
(10) Pub. No.: US 2023/0174334 A1
(43) Pub. Date: Jun. 8, 2023

(54) FLEXIBLE JACKET WITH INK MARKING ZONE IDENTIFICATION INDICATOR

(71) Applicant: PRINTING RESEARCH, INC., Dallas, TX (US)

(72) Inventor: Phillip JONES, Dallas, TX (US)

(21) Appl. No.: 18/076,520

(22) Filed: Dec. 7, 2022

Related U.S. Application Data
(60) Provisional application No. 63/287,062, filed on Dec. 7, 2021.

(51) Int. Cl. B65H 27/00

(52) U.S. Cl. CPC B65H 27/00; B65H 2404/1152; B65H 2301/5111; B65H 2511/12

(57) ABSTRACT

A removable flexible jacket for use in a printing press having a transfer cylinder for transferring a freshly printed substrate. The removable flexible jacket comprises a coated beaded sheet adhered to an plastic sheet, wherein a plurality of images are printed on a downwards facing side of the plastic sheet and visible through the upwards facing side of the coated beaded sheet, wherein the plurality of images provide indications of how to cut the sheet to size to fit different sized transfer cylinders and indications of zones of the flexible jacket to promote selective cleaning of the flexible jacket during use in transferring printed substrates.

### CROSS-REFERENCE TO RELATED APPLICATIONS

This application claims priority to U.S. Provisional Application No. 63/287,062 filed Dec. 7, 2021, and entitled “Flexible Jacket with Ink Marking Zone Identification Indicator,” which is incorporated by reference herein in its entirety.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

In the operation of a rotary offset printing press, freshly printed substrates, such as sheets or web material, are guided by transfer cylinders or the like from one printing unit to another, and then they are delivered to a sheet stacker or to a sheet folder/cutter unit, respectively. As used herein, the term “transfer cylinder” includes delivery cylinders, transfer rollers, support rollers, support cylinders, delivery wheels, skeleton wheels, segmented wheels, transfer drums, support drums, spider wheels, support wheels, guide wheels, guide rollers, and the like.

The ink marking problems inherent in transferring freshly printed substrates have been longstanding. In order to minimize the contact area between the transfer means and the freshly printed substrate, conventional support wheels have been modified in the form of relatively thin disks having a toothed or serrated circumference, referred to as skeleton wheels. However, those thin disc transfer means have not overcome the problems of smearing and marking the freshly printed substrate due to moving contact between the freshly printed substrate and the projections or serrations. Moreover, the attempts to cover the transfer cylinder with a cover material and/or minimize the surface support area in contact with the freshly printed substrate material often resulted in further problems.

Various efforts have been made to overcome the limitations of thin disk skeleton wheels. One of the most important improvements has been completely contrary to the concept of minimizing the surface area of contact. That improvement is disclosed and claimed in U.S. Pat. No. 3,791,644 to Howard W. DeMoore, incorporated by reference herein in its entirety, wherein the support surface of a transfer cylinder in the form of a wide wheel or cylinder is coated with an improved ink repellent surface formed by a layer of polytetrafluoroethylene (PTFE).

During the use of the PTFE coated transfer cylinders in high-speed commercial printing presses, the surface of the coated cylinders must be washed frequently with a solvent to remove any ink accumulation. Moreover, it has also been determined that the PTFE coated cylinders do not provide a cushioning effect and relative movement, which are beneficial.

The limitations on the use of the PTFE coated transfer cylinders have been overcome with an improved transfer cylinder having an ink repellent, cushioning, and supportive fabric covering or the like for transferring the freshly printed sheet. It is now well recognized and accepted in the printing industry world-wide that marking and smearing of freshly printed sheets caused by engagement of the wet printed surface with the supporting surface of a conventional press transfer cylinder is substantially reduced by using the anti-marking fabric covering system as disclosed and claimed in my U.S. Pat. No. 4,402,267 entitled “Method and Apparatus for Handling Printed Sheet Material,” the disclosure of which is incorporated herein by reference.

That system, which is marketed under license by Printing Research, Inc. of Dallas, Tex., U.S.A. under the registered trademark SUPER BLUE® includes the use of a low friction coating or coated material on the supporting surface of the transfer cylinder, and over which is loosely attached a movable fabric covering. The fabric covering provided a yieldable, cushioning support for the freshly printed side of the substrate such that relative movement between the freshly printed substrate and the transfer cylinder surface would take place between the fabric covering and the support surface of the transfer cylinder so that marking and smearing of the freshly printed surface was substantially reduced. Various improvements have been made to the SUPER BLUE® system, which are described in more detail in U.S. Pat. Nos. 5,907,998 and 6,244,178 each entitled “Anti-Static, Anti-Smearing Pre-Stretched and Pressed Flat, Precision-Cut Striped Flexible Coverings for Transfer Cylinders”; U.S. Pat. Nos. 5,511,480, 5,603,264, 6,073,556, 6,119,597, and 6,192,800 each entitled “Method and Apparatus for Handling Printed Sheet Material”; U.S. Pat. No. 5,979,322 entitled “Environmentally Safe, Ink Repellent, Anti-Marking Flexible Jacket Covering Having Alignment Stripes, Centering Marks and Pre-Fabricated Reinforcement Strips for Attachment onto Transfer Cylinders in a Printing Press”; and U.S. Pat. No. RE39,305 entitled “Anti-static, Anti-smearing Pre-stretched and Pressed Flat, Precision-cut Striped Flexible Coverings for Transfer Cylinders,” each of which is hereby incorporated by reference herein in its entirety. The above cited patents are all owned by Printing Research, Inc. of Dallas, Tex., U.S.A.

### SUMMARY

In an embodiment, a method of making a roll of film for use in forming removable flexible jackets for use in a printing press having a transfer cylinder for transferring a freshly printed substrate is disclosed. The method comprises adhering a downwards facing side of an extended sheet of beaded material to an upwards facing side of an extended sheet of plastic material; applying a coating over an upwards facing side of the extended sheet of beaded material; curing the coating using an ultraviolet light; and printing a plurality of images on a downwards facing side of the extended sheet of plastic material, wherein each of the plurality of images provides indications of where to cut a flexible jacket from the roll of film and of how to fit the flexible jacket to the transfer cylinder; and curing the printed plurality of images using an ultraviolet light, wherein the roll of film is made without a backing fabric and without a backing foam.

In another embodiment, a method of cutting a removable flexible jacket from a roll of film comprising an outwards facing coated beaded material adhered to a sheet of plastic material having a plurality of images printed on a downwards facing side of the plastic material and visible through the outwards facing coated beaded material, wherein the removable flexible jacket is for use in a printing press having a transfer cylinder for transferring a freshly printed substrate, and of installing the removable flexible jacket onto the transfer cylinder of the printing press is disclosed. The method comprises cutting a removable flexible jacket from the roll of film between a plurality of zones printed on the downwards facing side of the plastic material; cutting an operator edge side of the removable flexible jacket that has been cut from the roll of film based on a first width registration mark of the printed images proximate to a gripper operator zone portion of the printed images and based on a second width registration mark of the printed images proximate to a tail operator zone portion of the printed images; cutting a gear edge side of the removable flexible jacket that has been cut from the roll of film based on a third width registration mark of the printed images proximate to a gripper gear portion of the printed and based on a fourth width registration mark of the printed images proximate to a tail gear zone portion of the printed images; attaching a gripper edge to the transfer cylinder at a gripper edge of the transfer cylinder based on a gripper operator zone, a gripper center, and a gripper gear portion of the printed images; and attaching a tail edge to the transfer cylinder at a tail edge of the transfer cylinder, wherein the plurality of images printed on the downwards facing side of the plastic material of the removable flexible jacket is installed directly over the transfer cylinder.

In yet another embodiment, a removable flexible jacket for use in a printing press having a transfer cylinder for transferring a freshly printed substrate is disclosed. The removable flexible jacket comprises a coated beaded sheet adhered to an plastic sheet, wherein a plurality of images are printed on a downwards facing side of the plastic sheet and visible through the upwards facing side of the coated beaded sheet, wherein the plurality of images provide indications of how to cut the sheet to size to fit different sized transfer cylinders and indications of zones of the flexible jacket to promote selective cleaning of the flexible jacket during use in transferring printed substrates.

These and other features will be more clearly understood from the following detailed description taken in conjunction with the accompanying drawings and claims.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1A is an illustration of a flexible jacket according to an embodiment of the disclosure.

FIG. 1B is an illustration of a flexible jacket layered construction according to an embodiment of the disclosure.

FIG. 2 is an illustration of a flexible jacket according to an embodiment of the disclosure.

FIG. 3 is an illustration of a flexible jacket according to an embodiment of the disclosure.

FIG. 4A is a schematic side elevational view showing multiple transfer cylinders installed at substrate transfer positions in a four-color rotary offset printing press of a type made by Heidelberg Druckmaschinen Aktiengesellschaft.

FIG. 4B is a schematic side elevational view showing multiple transfer cylinders installed at substrate transfer positions in a four-color rotary offset printing press of the Lithrone Series made by Komori Corp.

FIG. 5 is a perspective view of a transfer cylinder of a type commonly used on printing presses made by Heidelberg Druckmaschinen Aktiengesellschaft.

FIG. 6A is a cross-sectional view of a transfer cylinder taken along line 15-15 of FIG. 4 having an integrated, anti-marking cover installed thereon.

FIG. 6B is a cross-sectional view of a transfer cylinder of a type commonly used on Lithrone Series printing presses made by Komori Corp.

### DETAILED DESCRIPTION

It should be understood at the outset that although illustrative implementations of one or more embodiments are illustrated below, the disclosed systems and methods may be implemented using any number of techniques, whether currently known or in existence. The disclosure should in no way be limited to the illustrative implementations, drawings, and techniques illustrated below, but may be modified within the scope of the appended claims along with their full scope of equivalents. As used herein, “inner” or “inward” when used with a description of a covering or cylinder refers to a direction towards the center of the cylinder. As used herein, “outer” or “outward” when used with a description of a covering or cylinder refers to a direction away from the center of the cylinder and towards a substrate contacting the cylinder or a flexible jacket on the cylinder.

In an embodiment, a transfer cylinder or other cylinder of a printing press may be at least partially enclosed by a flexible jacket that is installed over the cylinder. The flexible jacket may provide an anti-marking function to aid in transferring printed sheets without smearing ink on the printed sheets. In some contexts, the flexible jacket may be referred to as an anti-marking jacket. In an embodiment, the flexible jacket may have an ultraviolet curable coating that is easily cleaned and even allows relatively easy cleaning when ultraviolet ink has dried on the surface of the flexible jacket. In this case, the dried ultraviolet ink readily peels off or sloughs off during cleaning. It is thought that cleaning the anti-marking surface that has been coated with an ultraviolet coating as described above reduces damage to and/or removal of the projections coupled to the film sheet, because press operators are able to adequately clean the anti-marking surface using less physical pressure and less aggressive scrubbing action. In an embodiment, the surface of the flexible jacket may comprise a plurality of beads that create projections above an average surface level of the flexible jacket

It is a teaching of the present disclosure that the flexible jacket can provide one or more graphics or images that promote ease of cutting the flexible jacket to size and to promote ease of installation of the flexible jacket on a cylinder of the printing press. The images may be printed on a surface of the flexible jacket or encapsulated between a coating and a top surface of the flexible jacket. This image or images may also promote the cutting of flexible jackets from a roll of flexible jacket material. For example, a sheet of film may be manufactured as a roll of material suitable for cutting out a plurality of flexible jackets. The sheet of film produced as a roll may have a plurality of images printed on its surface or encapsulated between a coating and a top surface of the flexible jacket.

In an embodiment, the roll of film is formed by adhering a downwards facing side of an extended sheet of beaded material to an upwards facing side of an extended sheet of plastic material, for example acetate, acrylic, MYLAR, or other type of plastic sheet. The sheet of beaded material and the sheet of plastic material may have about the same dimensions of about 32 inches wide to about 50 meters long. Alternatively, the sheet of beaded material and the sheet of plastic material may have about the same dimensions of about 42 inches wide to about 50 meters long. After the sheet of beaded material is adhered in this way to the sheet of plastic material, a coating is applied to the upwards facing side of the extended sheet of beaded material. The coating is then cured using an ultraviolet light. After the coating is cured, the sheet of beaded material and the sheet of plastic material is turned over so the formerly downwards facing side of the sheet of plastic material (also known as the back of the plastic material) is facing upwards. With the back of the sheet of plastic material facing upwards, a plurality of images are printed on the back of the sheet of plastic material such that the images are visible through the sheet of beaded material when the roll of film is turned over again with the back of the sheet of plastic material facing downwards. With the back of the plastic material facing upwards, the printing of the plurality of images are cured using the ultraviolet light. The images comprise markings for cutting out individual instances of removable flexible jackets from the roll of film, for cutting the removable flexible jackets to size for installing on a transfer cylinder of a printing press, and for installing the removable flexible jackets onto the transfer cylinder. The images also comprising markings of zones of marking, such that a pressman can observe where undesired marking may occur on a printed substrate and readily appreciate where on the flexible jacket a cleaning operating is needed to prevent or ameliorate undesired marking by the flexible jacket going forwards.

It is understood that different sized flexible jackets for use with different sized transfer cylinders can be cut from the same roll of film by using registration markings among the plurality of images printed on the back of the plastic sheet. For example, flexible jackets for transfer cylinders having a width between 40 inches and 42 inches can be cut from the same roll of film. For example, flexible jackets for transfer cylinders having a width between 28.5 inches and 32 inches can be cut from the same roll of film.

In the busy environment of a press room, the printed images on the flexible jacket provide desired assistance to pressmen on how to install the flexible jacket onto the transfer cylinder. Cutting the flexible jackets from the roll of film avoid confusion of pressmen selecting the right sized jacket from pre-cut stock, attempting to install the wrong size flexible jacket, going back to the store room to try to find the right sized flexible jacket. The cutting can done at the press, at the transfer cylinder, which obviates errors knowing what size to use. The printed images on the flexible jacket provide desirable orientation of the flexible jacket to the gripper edge of the transfer cylinder, to the tail edge of the transfer cylinder, to the operator side of the transfer cylinder, and to the gear side of the transfer cylinder.

Previous embodiments of flexible jackets featured printed graphic images between layers of the flexible jackets that included a film or foam backer coupled to the printed graphic image layer and hence the graphic images were embedded within the flexible jackets. By contrast, the flexible jackets disclosed herein feature printed graphic images disposed on an external surface of the flexible jacket as disclosed herein (e.g., printed on the exterior of the plastic sheet on its outside, downwards facing side, next to the transfer cylinder when the flexible jacket is installed over the transfer cylinder). After identifying issues with wicking of cleaning solvents and testing it was determined the flexible jacket of the current disclosure (e.g., with printed graphic images on the exterior of the plastic sheet) still performs its anti-marking function well without the backer (e.g., without being embedded within the flexible jackets). Further, this disposition disclosed herein reduces the problems of solvent wicked in by the backer attacking the printed graphic images and/or the back side of the plastic sheet.

The Super See ZONE® and E-Zone Anti-Marking System are easy-to-use ZONE identification system consisting of specially coated Super See anti-marking film enhanced with a ZONE or numbered grid system. This product (e.g., the flexible jacket) is mounted on a transfer cylinder. It comes with a corresponding transparent Overlay sheet that the pressman uses at his press console. He can “ZONE” in on the specific area where marking is occurring and quickly communicate to his press crew where to clean the transfer jacket (e.g., the flexible jacket). This allows the pressman to continue with production related tasks and get his press back in production quickly.

Advantages include time savings, waste reduction, extended service life of flexible jackets, applicable to a large range of presses. The ZONE pattern allows a pressman to quickly identify the area on the transfer cylinder where marking is occurring and easily communicate to his press crew which ZONE to clean to eliminate the marking from the flexible jacket and get back up and running quickly. By cleaning only the affected area on the transfer cylinder vs. washing the entire cylinder surface, less solvent and wasted sheets (e.g., prematurely worn or damaged flexible jackets that need to be replaced with a new flexible jacket) are consumed. Cleaning just the specific ZONE on the transfer cylinder (e.g., cleaning the flexible jacket) extends the life of the Anti-Marking Jacket. Extensive use of solvents and scrubbing of the entire cylinder surface increases the wear of the Anti-Marking Jacket. The Super See ZONE® and the E-Zone are available for many printing press makes and models (e.g., Heidelberg, Komori, KBA, Man Roland, Mitsubishi, Ryobi, etc.) that have solid transfer cylinders.

In an embodiment, the flexible jacket is treated with a UV coating. Competitor's coatings are silicone which is less repellent and will not withstand cleaning like ours. In an embodiment, the Super See Zone is numbered but the E-Zone is sectioned off specially. In an embodiment, the graphical sectioning includes Gripper Gear, Gripper Center, Gripper Operator, Middle Gear, Middle Center, Middle Operator, Tail Gear, Tail Center, and Tail Operator sections.

In an embodiment, starting at the layer closest to the printed sheet, a coating is applied comprising one or more of Glass or reflective bead, adhesive, Plastic base, Graphic printed on or laminated to plastic base, adhesive backer. The E-zone can be implemented on sheets and with the supplied cutting instructions reduce the cost of the product to end customers who buy it in rolls and cutting it down to the size of the flexible jacket on their own.

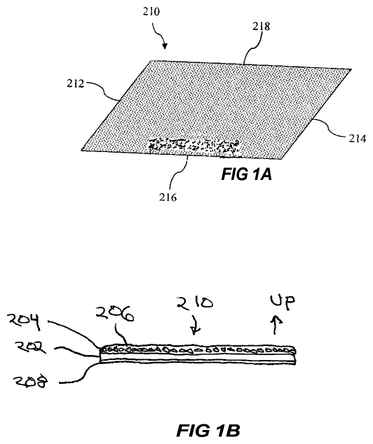

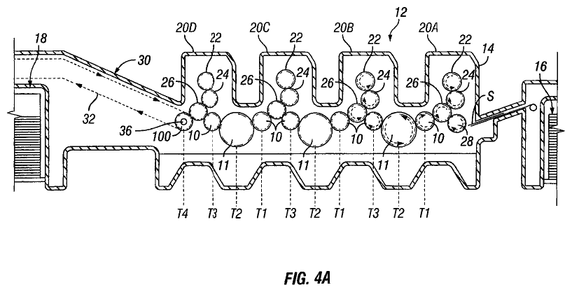

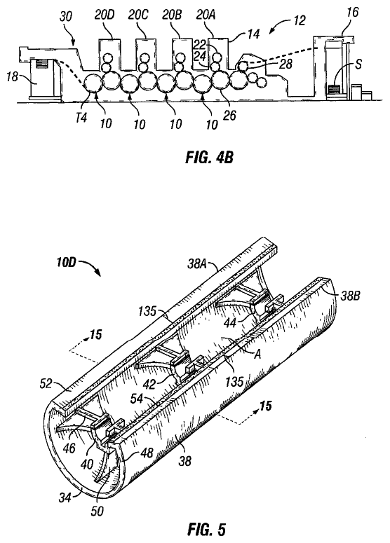

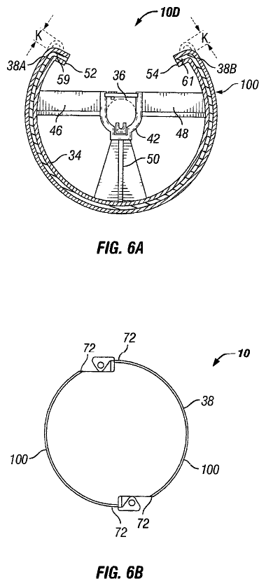

Turning now to FIG. 1A, a flexible jacket 210 is described. The flexible jacket 210 has a gripper edge 212, a tail edge 214, a gear edge 216, and an operator edge 218. The flexible jacket 210 is generally a thin rectangular sheet. In an embodiment, the flexible jacket 210 may have attaching mechanisms for coupling the flexible jacket 210 to a transfer cylinder of a printing press. In some contexts, the flexible jacket 210 may be referred to as a removable flexible jacket, as it may be installed onto the transfer cylinder and removed from the transfer cylinder. Transfer cylinders and printing press structures and operation are assumed to be well known, but some brief description of these conventional structures is provided herein below with reference to FIG. 4A, FIG. 4B, FIG. 5, FIG. 6A, and FIG. 6B. The surface of the flexible jacket 210 visible in FIG. 1A is an outer surface of the flexible jacket 210 and may be referred to in some contexts as an anti-marking surface. In use, the outer surface of the flexible jacket 210 may partially contact printed substrates as they are passed over the transfer cylinder through the printing press.

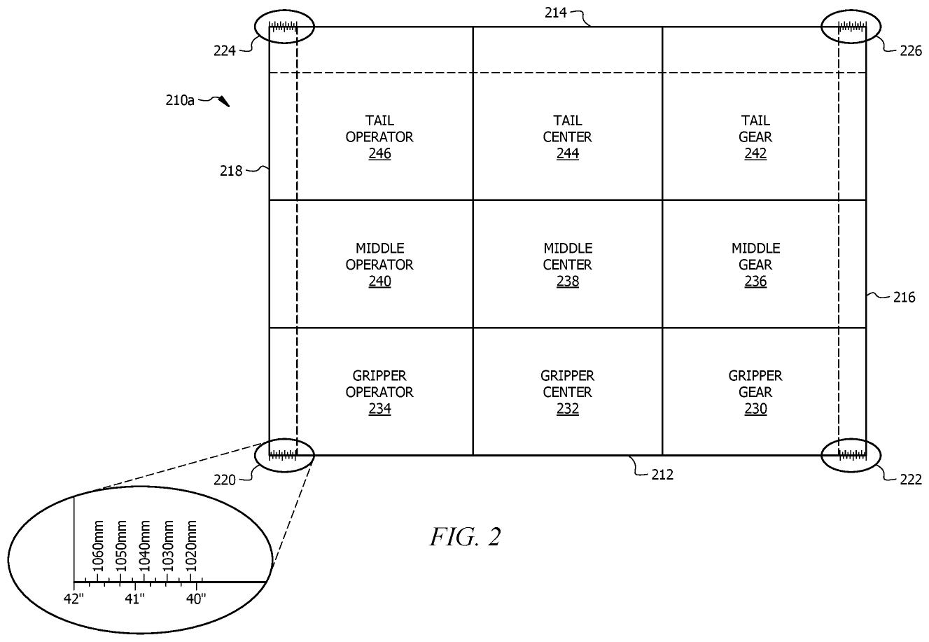

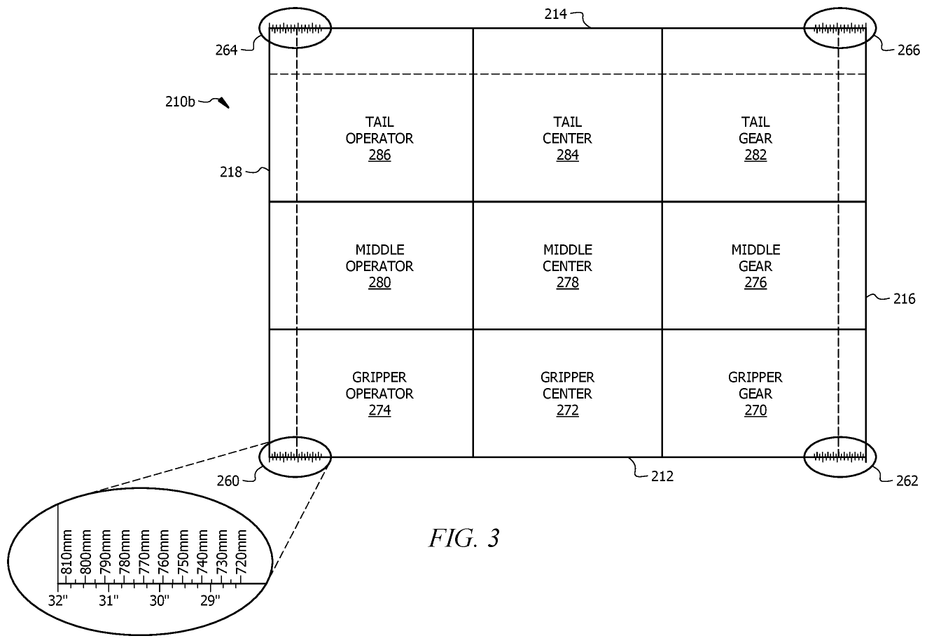

For exemplary purposes, a flexible jacket 100 will be described with reference to the processing of sheet substrates in FIG. 4A, FIG. 5, FIG. 6A, and FIG. 6B below. This flexible jacket 100 is the same as the flexible jacket 210 described with reference to FIG. 1A, FIG. 1B, FIG. 2, and FIG. 3. However, it will be understood that the principles of the disclosure are equally applicable to web substrates. The flexible jacket 100 may be implemented as any one of the flexible jackets described herein. The flexible jacket 100 of the present disclosure may be used in combination with high-speed printing press equipment of the type used, for example, in offset printing. FIG. 4A shows a typical, four color offset printing press of the type made by Heidelberg Druckmaschinen Aktiengesellschaft, and FIG. 4B shows a four-color offset printing press of the Lithrone Series available from Komori Corp. Referring to FIGS. 4A and 4B, such equipment includes one or more transfer cylinders 10 for handling a processed substrate, such as a freshly printed sheet between printing units and upon delivery of the printed sheet to a delivery stacker. The flexible jacket 100 of the present disclosure and the optional base cover are installed on transfer cylinders 10. As used herein, the term “processed” refers to various printing methods, which may be applied to either side or both sides of a substrate, including the application of aqueous inks, protective coatings and decorative coatings. The term “substrate” refers to sheet material or web material.

Use of the present disclosure, in combination with the transfer cylinder 10 at an interstation transfer position (T1, T3) or at a delivery position (T4) in a typical rotary offset printing press 12, is believed to be readily understandable to those skilled in the art. In any case, reference may be made to U.S. Pat. Nos. 3,791,644 and 4,402,267, which disclose details regarding the location and function of a sheet support cylinder in a typical multistation printing press. The present disclosure may, of course, be utilized with conventional printing presses having any number of printing units or stations.

Referring to FIG. 1B, the layered construction of the flexible jacket 210 is described. In an embodiment, the flexible jacket 210 comprises a beaded sheet 204 that is adhered to an plastic sheet 202. A coating 206 is applied over the upwards facing side of the beaded sheet 204 and cured by an ultraviolet light. The flexible jacket 210 may be turned upside down so the previously down facing side of the plastic sheet 202 is facing up, and a plurality of graphic images 208 printed on the previously down facing side of the plastic sheet 202. The graphic images 208 may be cured by an ultraviolet light. The flexible jacket 210 may then be returned to its normal orientation with the printed graphic images 208 on a bottom side of the flexible jacket 210 and with the coating 206 on a top side of the flexible jacket 210. It is understood that the flexible jacket 210 can be manufactured in a roll of film where many flexible jackets are intended to be cut form the roll of film as need arises at a press shop. It is noted that the flexible jacket 210 has no backing fabric and no backing foam between the printed graphic images 208 and the down facing side of the plastic sheet 202. Thus, when installed over the transfer cylinder on a press, there is no other layer between the printed graphic images 208 and the transfer cylinder.

Referring to FIG. 2, a first embodiment of the flexible jacket 210a having graphic indications on its surface or embedded within the flexible jacket is shown. The flexible jacket 210a may be cut from the roll of film described above comprising a beaded sheet adhered to a plastic sheet, having a coating on top of the beaded sheet, and having printed graphical images on the back of the plastic sheet.

The graphic indications comprise a first registration marking 220, a second registration marking 222, a third registration marking 224, and a fourth registration marking 226. In some contexts, the registration markings 220-226 may be referred to as width registration marks. The graphic indications comprise a centerline marking. In cutting the flexible jacket 210a to shape, the operator or pressman aligns the outside edges of the transfer cylinder with registration markings 220, 222, 224, 226. If the transfer cylinder is 41 inches wide, the operator aligns the 41 inches mark of the first registration marking 220 with the operator edge of the transfer cylinder and the 41 inches mark of the second registration marking 222 with the gear edge of the transfer cylinder. If the operator has aligned instead the 42 inches mark of the first registration marking 220 with the operator edge of the transfer cylinder and the 40 inches mark of the second registration marking 222 with the gear edge of the transfer cylinder, this asymmetry immediately indicates to the operator that the flexible jacket 210a is misaligned, and the operator corrects the alignment accordingly.

The graphic indications of the flexible jacket 210a further comprise a gripper gear zone indication 230, a gripper center zone indication 232, a gripper operator zone indication 234, a middle gear zone indication 236, a middle center zone indication 238, a middle operator zone indication 240, a tail gear zone indication 242, a tail center zone indication 244, and a tail operator zone indication 246. The zone indications 230-246 provide assistance to the operator in aligning the flexible jacket 210a to the transfer cylinder during installation and later during operation for determining where to clean the flexible jacket 210a to stop marking of printed substrates or to ameliorate marking of printed substrates.

In an embodiment, instructions for cutting and mounting the flexible jacket 210a may be printed on the roll of film between the zone markings 230-246 between adjacent flexible jackets 210a. The instructions may include: (1) measure from the center mark, half the distance of the total width of the cylinder; (2) use the marks (e.g., the registration marks 220, 222, 224, 226) on the corners of the sheet to keep the sides square while trimming; (3) trim both sides to match the width of the cylinder; (4) trim the gripper edge along the line provided (e.g., the line of the zone markings); and (5) measure the circumference dimension from the gripper edge to the tail. This may result in a little wastage of material but may provide the convenience of having the instructions ready-to-hand at the press when they are needed and not misplaced or lost. In another embodiment, the instructions may be printed on a separate sheet of paper.

Referring to FIG. 3, a second embodiment of the flexible jacket 210b having graphic indications on its surface or embedded within the flexible jacket is shown. The flexible jacket 210b is substantially similar to the flexible jacket 210a described above with reference to FIG. 2 described above except that it is narrower and is intended for narrower transfer cylinders, for example transfer cylinders ranging from about 28.5 inches wide to about 32 inches wide. The graphic indications comprise a fifth registration marking 260, a sixth registration marking 262, a seventh registration marking 264, and an eighth registration marking 266. In some contexts, the registration markings 260-266 may be referred to as width registration marks. The graphic indications comprise a centerline marking. In cutting the flexible jacket 210b to shape, the operator or pressman aligns the outside edges of the transfer cylinder with registration markings 260, 262, 264, 266. If the transfer cylinder is 30 inches wide, the operator aligns the 30 inches mark of the fifth registration marking 260 with the operator edge of the transfer cylinder and the 30 inches mark of the sixth registration marking 262 with the gear edge of the transfer cylinder.

The graphic indications of the flexible jacket 210b further comprise a gripper gear zone indication 270, a gripper center zone indication 272, a gripper operator zone indication 274, a middle gear zone indication 276, a middle center zone indication 278, a middle operator zone indication 280, a tail gear zone indication 282, a tail center zone indication 284, and a tail operator zone indication 286. The zone indications 270-286 provide assistance to the operator in aligning the flexible jacket 210b to the transfer cylinder during installation and later during operation for determining where to clean the flexible jacket 210b to stop marking of printed substrates or to ameliorate marking of printed substrates. As with the flexible jacket 210a described above with reference to FIG. 2, instructions for cutting and mounting the flexible jacket 210b may be printed on the roll of film between the zone markings 270-286 between adjacent flexible jackets 210b. Alternatively, the instructions may be printed on a separate piece of paper.

In an embodiment, a method of cutting a removable flexible jacket from a roll of film comprising an outwards facing coated beaded material adhered to a sheet of plastic material having a plurality of images printed on a downwards facing side of the plastic material and visible through the outwards facing coated beaded material, wherein the removable flexible jacket is for use in a printing press having a transfer cylinder for transferring a freshly printed substrate, and of installing the removable flexible jacket onto the transfer cylinder of the printing press comprises the following operations. First, cutting a removable flexible jacket from the roll of film between a plurality of zones printed on the downwards facing side of the plastic material. Second, cutting an operator edge side of the removable flexible jacket that has been cut from the roll of film based on a first width registration mark of the printed images proximate to a gripper operator zone portion of the printed images and based on a second width registration mark of the printed images proximate to a tail operator zone portion of the printed images. Third, cutting a gear edge side of the removable flexible jacket that has been cut from the roll of film based on a third width registration mark of the printed images proximate to a gripper gear portion of the printed and based on a fourth width registration mark of the printed images proximate to a tail gear zone portion of the printed images. Fourth, attaching a gripper edge to the transfer cylinder at a gripper edge of the transfer cylinder based on a gripper operator zone, a gripper center, and a gripper gear portion of the printed images. Fifth, attaching a tail edge to the transfer cylinder at a tail edge of the transfer cylinder. The method results in the printed graphic images being installed directly over the transfer cylinder with no intervening layer of material or coating. The method results in the printed graphic images being installed directly over the transfer cylinder with no backing fabric and no backing foam between the transfer cylinder and the printed graphic images.

It will be appreciated that the method of cutting a flexible jacket from the roll of film may be altered in various ways. For example, the order of cutting the operator edge and the gear edge of the flexible jacket may be reversed. Additionally, the method may further comprise cutting a gripper edge along a line defined by the graphic images printed on the flexible jacket. The method may comprise cutting off instructions that are printed on the roll of film between the zone markings. The method may comprise cutting at a tail edge of the flexible jacket to size to the circumference of the transfer cylinder.

Referring to FIGS. 4A and 4B, the press 12 includes a press frame 14 coupled on its input end to a sheet feeder 16 from which sheets, herein designated S, are individually and sequentially fed into the press. At its delivery end, the press 12 is coupled to a sheet stacker 18 in which the printed sheets are collected and stacked. Interposed between the sheet feeder 16 and the sheet stacker 18 are four substantially identical sheet printing units 20A, 20B, 20C, and 20D which are capable of printing different color inks onto the sheets as they are transferred through the press.

As illustrated in FIGS. 4A & 4B, each printing press is of conventional design, and includes a plate cylinder 22, a blanket cylinder 24, and an impression cylinder 26. Freshly printed sheets S from the impression cylinder 26 are transferred to the next printing press by a transfer cylinder 10. The initial printing unit 20A is equipped with a sheet in-feed roller 28 which feeds individual sheets one at a time from the sheet feeder 16 to the initial impression cylinder 26. In an embodiment, the transfer cylinder 10 may be painted a color that promotes discernment of negatively defined visual stripes in the optional base cover by a print operator.

The freshly printed sheets S are transferred to the sheet stacker 18 by a delivery conveyor system, generally designated 30. The delivery conveyor system 30 is of conventional design and includes a pair of endless delivery gripper chains 32 carrying transversely disposed gripper bars, each having gripper elements for gripping the leading edge of a freshly printed sheet S as it leaves the impression cylinder 26 at the delivery position T4. As the leading edge of the printed sheet S is gripped by the grippers, the delivery gripper chains 32 pull the gripper bars and sheet S away from the impression cylinder 26 and transport the freshly printed sheet S to the sheet delivery stacker 18.

Referring to FIG. 4A, an intermediate transfer cylinder 11 receives sheets printed on one side from the transfer cylinder 10 of the preceding printing unit 20. Each intermediate transfer cylinder 11, which is of conventional design, typically has a diameter twice that of the transfer cylinder 10, and is located between two transfer cylinders 10, at interstation transfer positions T1, T2 and T3, respectively. The impression cylinders 26, the intermediate transfer cylinders 11, the transfer cylinders 10, as well as the sheet in-feed roller 28, are each provided with sheet grippers which grip the leading edge of the sheet to pull the sheet around the cylinder in the direction as indicated by the associated arrows. The transfer cylinder 10 in the delivery position T4 is not equipped with grippers, and includes instead a large longitudinal opening A, which provides clearance for passage of the chain driven delivery conveyor gripper bars. In some printing press installations, an artificial radiation source, for example an ultraviolet lamp and/or an infrared lamp, may be mounted to radiate semi-directly or directly onto the interstation transfer positions T1, T2, and T3. The artificial radiation may be employed to cure and/or set the wet ink on printed substrates as they pass through the printing press.

Referring now to FIGS. 5 and 6A, a preferred transfer cylinder 10D is shown for use with the Heidelberg printing press of FIG. 4A. The flexible jacket 100 described herein above is installed on a transfer cylinder 10D on the last printing unit 20D of the press 12 in the delivery position (T4) and has a cylindrical rim 34, which is supported for rotation on the press frame 14 by a rotatable delivery shaft 36. The external cylindrical surface 38 of the cylindrical rim 34 has a gap “A” extending longitudinally along the length of the transfer cylinder 10D and circumferentially between gripper edge 38A and tail edge 38B, respectively. The transfer cylinder 10D is attached to the delivery shaft 36 by longitudinally spaced hubs 40, 42 and 44. Additionally, center alignment marks 135 are formed on the cylinder flanges portions 52, 54 and on the external cylindrical surface 38 of the cylindrical rim 34, as shown in FIG. 5. The purpose of the center alignment marks 135 is to facilitate the precise alignment and attachment of the flexible jacket 100 and/or the optional base cover to the transfer cylinder 10D. In an embodiment, a center alignment mark 135 may also be provided on the flexible jacket 100.

The hubs 40, 42, and 44 are connected to the cylindrical rim 34 by webs 46, 48 and 50, and support the transfer cylinder 10D for rotation on the delivery shaft 36 of the printing press 12 in a manner similar to the mounting arrangement disclosed in U.S. Pat. No. 3,791,644. In the embodiment shown in FIG. 5, the delivery cylinder 10D includes opposed cylinder flanges 52, 54, which extend generally inwardly from the surface of the cylindrical rim portion 34. The flanges 52 and 54 include elongated flat surfaces for securing the flexible jacket 100 as described below. As described herein, transfer cylinders may have alternative configurations for accommodating the various means for releasably attaching the flexible jacket 100 and the optional base cover to the transfer cylinder 10 as described herein.

Referring to FIG. 6B, a cross-sectional view of preferred transfer cylinder 10 is shown for use with the Lithrone Series printing press of FIG. 4B. Transfer cylinder 10 is designed and configured to accept a pair of flexible jackets 100, with a first flexible jacket 100 covering about one-half of the cylindrical surface 38 of the transfer cylinder 10 and a second flexible jacket 100 covering about the remaining one-half of the cylindrical surface 38. The flexible jacket 100 is releasably attached to the transfer cylinder 10 at the jacket tail edge and the jacket gripper edge with flat clamp bar 72 held in place with a series of spring-loaded screws spaced along the length of the clamp bar 72. In some cases, the flexible jacket 100 is attached by various means including, but not limited to, hook and loop fabric material such as VELCRO that mates adheringly to the flexible jacket 100, an adhesive strip or tape, and other adhering means. For example, the adhesive strip may be coupled on one side to the flexible jacket 100 through one of a heating process and a pressure process. In embodiment, a portion of the adhesive strip may be extruded through an edge of the flexible jacket 100 to couple the adhesive strip to the flexible jacket 100. For example, the extruded portion of the adhesive strip may form end caps or structures like rivets on the opposite side of the flexible jacket 100 to secure the adhesive strip to the flexible jacket 100. The extruded portion of the adhesive strip may partially form an interlocking matrix on the opposite side of the flexible jacket 100 to secure the adhesive strip to the flexible jacket 100. In an embodiment, a portion of the flexible jacket 100 along the edge may be abraded to provide a more suitable mating surface for coupling to a hook and loop fastener, for example VELCRO. In an embodiment, the flexible jacket 100 may be precision cut to promote simple installation, and in some embodiments, proper free play without adjustment. It is contemplated that the flexible jacket 100, taught by the present disclosure, may provide extended usage cycles relative to known designs for flexible jackets. The flexible jacket 100 may be removed, washed, and reinstalled multiple times before the flexible jacket 100 wears out.

The function and operation of the transfer cylinders 10 and associated grippers of the printing units 20 are believed to be well known to those familiar with multi-color sheet fed presses, and need not be described further except to note that the impression cylinder 26 functions to press the sheets against the blanket cylinders 24 which applies ink to the sheets, and the transfer cylinders 10 guide the sheets away from the impression cylinders 26 with the wet printed side of each sheet facing against the support surface of the transfer cylinder 10. Since each transfer cylinder 10 supports the printed sheet with the wet printed side facing against the transfer cylinder support surface, the transfer cylinder 10 is provided with the flexible jacket 100 and the optional base cover as described herein. The flexible jacket 100 and the optional base cover are releasably attached to the transfer cylinder 10 by means for releasably attaching the flexible jacket 100 and the optional base cover to a transfer cylinder 10. In an embodiment shown in FIG. 6A, the flexible jacket 100 is connected to the transfer cylinder flanges 52 and 54 by the hook and loop (i.e., VELCRO) fastener strips 59 and 61. Alternatively, the flexible jacket 100 may be, at least partially, connected to the transfer cylinder 10 using adhesive strip, as described above. In an embodiment shown in FIG. 4A, the flexible jacket 100 may be attached to the transfer cylinder flanges 52 and 54 by mechanical mechanisms, for example by mechanical fasteners such as screws; mechanical take up reels or any other forms of mechanical roll up bars (often referred to collectively as reel cylinders); and the like. The flexible jacket 100 may have rods extending through loops in a gripper edge and a tail edge, and the flexible jacket 100 may attach the to the transfer cylinder 10 by snapping the rods over receiving screws at the corresponding edges of the transfer cylinder 10.

As noted above, the blanket cylinders 24 may comprise ink repellant flexible jackets or coverings similar to those described herein. The coverings may be used when a wet ink side of a sheet is being pressed against the blanket cylinder 24, for example, when the opposite side of a freshly printed image is being printed upon. The covering for the blanket cylinder 24 may comprise the image including a zoned reference that can be used to locate a potential portion of the blanket cylinder covering causing a marking problem, as described in more detail herein.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What we claim is:

1. A method of making a roll of film for use in forming removable flexible jackets for use in a printing press having a transfer cylinder for transferring a freshly printed substrate, comprising:
adhering a downwards facing side of an extended sheet of beaded material to an upwards facing side of an extended sheet of plastic material;
applying a coating over an upwards facing side of the extended sheet of beaded material;
curing the coating using an ultraviolet light; and
printing a plurality of images on a downwards facing side of the extended sheet of plastic material, wherein each of the plurality of images provides indications of where to cut a flexible jacket from the roll of film and of how to fit the flexible jacket to the transfer cylinder; and
curing the printed plurality of images using an ultraviolet light, wherein the roll of film is made without a backing fabric and without a backing foam.

2. The method of claim 1, wherein the plurality of images comprise registration marks providing indications where to cut the flexible jacket to a width to fit different sized transfer cylinders.

3. The method of claim 1, wherein the plurality of images comprise zone markings indicating a gripper side and a tail side, indicating an operator side and a gear side, and indicating a center.

4. The method of claim 3, wherein the zone markings provide indications of where to clean the flexible jacket cut from the roll of film.

5. The method of claim 1, wherein the plurality of images comprise instructions for cutting a flexible jacket and for installing a flexible jacket on a transfer cylinder.

6. A method of cutting a removable flexible jacket from a roll of film comprising an outwards facing coated beaded material adhered to a sheet of plastic material having a plurality of images printed on a downwards facing side of the plastic material and visible through the outwards facing coated beaded material, wherein the removable flexible jacket is for use in a printing press having a transfer cylinder for transferring a freshly printed substrate, and of installing the removable flexible jacket onto the transfer cylinder of the printing press, comprising:
cutting a removable flexible jacket from the roll of film between a plurality of zones printed on the downwards facing side of the plastic material;
cutting an operator edge side of the removable flexible jacket that has been cut from the roll of film based on a first width registration mark of the printed images proximate to a gripper operator zone portion of the printed images and based on a second width registration mark of the printed images proximate to a tail operator zone portion of the printed images;
cutting a gear edge side of the removable flexible jacket that has been cut from the roll of film based on a third width registration mark of the printed images proximate to a gripper gear portion of the printed and based on a fourth width registration mark of the printed images proximate to a tail gear zone portion of the printed images;
attaching a gripper edge to the transfer cylinder at a gripper edge of the transfer cylinder based on a gripper operator zone, a gripper center, and a gripper gear portion of the printed images; and
attaching a tail edge to the transfer cylinder at a tail edge of the transfer cylinder, wherein the plurality of images printed on the downwards facing side of the plastic material of the removable flexible is installed directly over the transfer cylinder.

7. The method of claim 6, wherein the width registration marks indicate from 28.5 inches to 32 inches.

8. The method of claim 7, wherein the width registration marks further indicate from 720 mm to 810 mm.

9. The method of claim 6, wherein the width registration marks indicate from 40 inches to 42 inches.

10. The method of claim 9, wherein the width registration marks further indicate from 1020 mm to 1060 mm.

11. A removable flexible jacket for use in a printing press having a transfer cylinder for transferring a freshly printed substrate, comprising:
a coated beaded sheet adhered to a plastic sheet, wherein a plurality of images are printed on a downwards facing side of the plastic sheet and visible through the upwards facing side of the coated beaded sheet, wherein the plurality of images provide indications of how to cut the sheet to size to fit different sized transfer cylinders and indications of zones of the flexible jacket to promote selective cleaning of the flexible jacket during use in transferring printed substrates.

12. The removable flexible jacket of claim 11, wherein the plurality of images comprise width registration marks that indicate from 28.5 inches to 32 inches.

13. The removable flexible jacket of claim 12, wherein the width registration marks further indicate from 720 mm to 810 mm.

14. The removable flexible jacket of claim 11, wherein the plurality of images comprise width registration marks that indicate from 40 inches to 42 inches.

15. The removable flexible jacket of claim 14, wherein the width registration marks further indicate from 1020 mm to 1060 mm.

16. The removable flexible jacket of claim 11, wherein the indications of zones comprise a gripper gear zone, a gripper center zone, a gripper operator zone, a middle gear zone, a middle center zone, a middle operator zone, a tail gear zone, a tail center zone, and a tail operator zone.

17. The removable flexible jacket of claim 11, wherein the plastic sheet is a sheet of acetate material.

18. The removable flexible jacket of claim 11, wherein the plastic sheet is a sheet of acrylic material.
